(19) United States
(12) Patent Application Publication
(10) Pub. No.: US 2009/0071434 A1
(43) Pub. Date: Mar. 19, 2009

(54) LOW HEAT REJECTION HIGH EFFICIENCY INTERNAL COMBUSTION ENGINE

(76) Inventors: Shaun T. MacMillan, Peyton, CO (US); Barton R. Dwight, Basalt, CO (US)

Correspondence Address: MARSH, FISCHMANN & BREYFOGLE LLP, 8055 East Tufts Avenue, Suite 450, Denver, CO, 80237, US

(21) Appl. No.: 12/136,244

(22) Filed: Jun. 10, 2008

Related U.S. Application Data
(60) Provisional application No. 60/973,672, filed on Sep. 19, 2007.

(51) Int. Cl. F02F 3/16

(52) U.S. Cl. 123/193.6; 92/172

(57) ABSTRACT

An internal combustion engine including a low thermal capacity, low thermal conductivity insulating liner is provided. The insulating liner may be positioned to line the combustion chamber and a portion of the cylinder wall. The insulating liner may comprise a high aspect morphology sintered ceramic material and may further include a surface coating. The internal combustion engine may be a four-stroke diesel engine with variable valve timing operating using an asymmetric cycle. Through the asymmetric cycle and insulative properties of the insulating liner, the heat loss of the disclosed internal combustion engine is significantly less than that of a similar conventional internal combustion engine, resulting in significant efficiency improvements.

### RELATED APPLICATIONS

This application claims priority from U.S. Provisional Patent Application Ser. No. 60/973,672, filed Sep. 19, 2007, entitled “Low Heat Rejection High Efficiency Internal Combustion Engine,” the entire disclosure of which is incorporated by reference in its entirety herein.

### FIELD OF THE INVENTION

The present invention relates to internal combustion engines (“ICEs”), and more particularly to high efficiency ICEs capable of running at relatively low heat rejection rates and related methods.

### BACKGROUND OF THE INVENTION

A typical ICE will have cooling losses in the order of 30 to 40 percent of the total losses of the engine. In an attempt to minimize these losses, combustion chamber insulation has been proposed. The insulation typically has the effect of raising the temperature within the combustion chamber since less of the heat energy of combustion is able to escape the chamber through the chamber walls and be transferred to a cooling system. The higher combustion chamber temperatures generally result in higher operating temperatures and higher exhaust temperatures, which represent another path of potential heat loss and reduced efficiency. To overcome this, turbocharging may be used to recapture some of the heat energy within the exhaust gases. However, turbochargers add complexity and weight and have their own efficiency losses.

A previously proposed scheme for insulating a combustion chamber is to insulate the top of the piston and/or the surfaces of the cylinder head within the combustion chamber. Another proposed type of scheme is a top hat design wherein an insulative sleeve equal to or greater than the stroke length of the piston is located within the cylinder and the piston rings are located a distance from the top of the piston equal to or greater than the stroke length of the piston. In this manner, the combustion gases may avoid being directly exposed to the frictional surfaces between the piston and the cylinder. However, significant additional complexity may be required to ensure piston alignment within the cylinder and to prevent the top of the piston from coming in contact with and damaging the insulated portion of the cylinder wall. Previous insulation schemes have generally been coupled to higher operating temperatures. Higher operating temperatures tend to increase mechanical stresses and may require relatively expensive materials and production methods. Higher operating temperatures may also bring about durability and reliability concerns.

### SUMMARY OF THE INVENTION

In view of the foregoing, an object of the present invention is to provide a high efficiency ICE that is operable to run with relatively low heat rejection rates. In embodiments of ICEs described herein, an insulating liner is provided to limit the heat flow from the combustion gases to the surrounding engine components. The insulating liner may include portions lining the top of a piston and the combustion chamber. The insulating liner may also include portions along a region of the cylinder wall and may be configured to balance insulation performance with mechanical performance. In this regard, the insulating liner on the cylinder wall may be placed in a region close to the combustion chamber where the maximum heat flow through the cylinder wall typically occurs. Regions of the cylinder wall more distal to the combustion chamber, where typically less heat loss occurs, may be constructed using standard cylinder wall materials (e.g., cast iron). Piston rings disposed on a piston may be positioned so that they do not come into contact with the insulating cylinder wall liner. In this regard, the size of the cylinder wall liner and position of the piston rings may be selected to balance insulation performance with mechanical performance and simplicity.

The insulating liner may work in conjunction with an asymmetric engine operating cycle to enable the operation of ICEs as described herein with decreased heat rejection rates, both through the periphery of the combustion chamber and via the exhaust gases, and corresponding increases in engine efficiency. For example, embodiments of ICEs described herein may be operable to ingest one-third to one-half less of a charge (e.g., mass of air and fuel) than a similarly configured prior art ICE. Because of the insulative lining, when this smaller charge is ignited during the combustion process, the heat from the combustion process may be restricted from flowing out of the combustion chamber. Consequently, the combustion gases may remain at a higher pressure, which in turn may impart a greater amount of force on the cylinder. This may enable a greater amount of the energy within the combustion gases to be converted to mechanical movement of the piston. In addition, an asymmetric engine cycle may be utilized. For example, an Atkinson cycle, wherein the effective length of the intake stroke is shorter than the length of the power stroke, may be utilized. As such, the overexpansion relative to the intake stroke will allow an even greater degree of energy to be extracted from the combustion gases and result in a corresponding increase in efficiency. In this regard, the gases exhausted from the cylinder may be at a lower temperature than a similarly configured prior art ICE. In a prior art ICE, the energy loss associated with high exhaust gas temperatures may be partially recaptured by a turbocharger. In embodiments of ICEs described herein, the lower temperature exhaust gases and corresponding reduced energy loss may render turbocharging unnecessary and/or unsuitable.

Insulation materials described herein combine low heat capacity with low heat conductivity. The low heat conductivity prevents the flow of heat from the combustion gases to the components around the periphery of the combustion chamber. The low heat capacity results in a relatively low amount of energy being stored in the insulation material during any particular engine cycle. The low amount of heat storage may result in incoming charges during an intake stroke heated to a lesser degree than what typically occurs in a conventional ICE. This is in part due to the relatively low amount of energy stored in the insulation that is available for transfer to the incoming gases. Accordingly, the insulation may comprise a high aspect ratio sintered ceramic material or non-fibrous systems such as aerogels (a low-density solid-state material derived from gel in which the liquid component of the gel has been replaced with gas). Where the insulation is a high aspect ratio sintered ceramic material, the material may include Alumina Enhanced Thermal Barrier (“AETB”) used by NASA in the space shuttle program.

The above objectives and additional advantages are realized by the present invention. In one aspect an ICE is provided comprising a piston assembly in a cylinder, a combustion chamber defined by the cylinder and a top surface of the piston and an insulating liner. The cylinder may include a cylinder wall and a cylinder head. The piston assembly may include a piston and at least one sealing ring. The insulating liner may include a piston liner on the top surface of the piston, a cylinder head liner disposed on the combustion chamber surface of the cylinder head, and a cylinder wall liner disposed between the cylinder head and the at least one sealing ring when the piston is in a Top Dead Center (“TDC”) position. The length of the cylinder wall liner along a movement axis of the piston may be less than a stroke length of the piston.

In an embodiment, a sealing ring of the piston may be located closer to the top surface of the piston than to a bottom of the piston. Indeed, a sealing ring may be located in the top third of the piston. In an embodiment, the insulating liner may have a thickness of greater than 0.001 inches. Various portions of the insulating liner may be configured differently than other portions of the insulating liner.

In an arrangement, the insulating liner may comprise AETB. In an embodiment, the insulating liner may have a thermal conductivity of at most 1.5 W/m·K and a specific thermal capacity of at most 1,200 J/kg·K. In an embodiment, the insulating liner may have a thermal diffusivity of less than about 1.3×10⁻⁵ m²/s. The thermal diffusivity may be about 1.3×10⁻⁶ m²/s. The insulating liner may have an operating temperature range with an upper limit of 1,425 to 1,670 degrees Celsius.

In an embodiment, the insulating liner may comprise an open porosity ceramic that includes high aspect ratio morphology material. The aspect ratio of the morphology of the material may be at least 20-to-one. The material may include alumina, zirconia, chromia, thoria, magnesia, carbon, silica or any combination thereof. The porosity of the insulating liner may be at least 85 percent.

In an arrangement, the insulating liner may include a coating. The coating may have a thermal conductivity of at most 1.5 W/m·K and a thermal capacity of at most 1,400 J/kg·K. The coating may comprise one or more materials selected from a group consisting of porous alumina, zirconia, chromia, thoria, magnesia, carbon and silica. In an arrangement, the insulating liner may include a coating comprising zirconia and silica.

The insulating liner may include a portion lining the piston between the top surface of the piston and the sealing ring. The insulating liner may include portions lining the bottom surfaces of intake and exhaust valves.

In an embodiment, the ICE may be configured such that a power stroke of the ICE is longer than an effective intake stroke. In an embodiment, the ICE may be operable to function using an asymmetric cycle such as a four-stroke Atkinson cycle. The ratio of the length of the power stroke to the effective length of the intake stroke may be variable between 5:1 and 1.05:1 through the use of variable valve timing. The ICE may be operable to run using a diesel cycle.

In another aspect, an internal combustion engine is provided that includes a piston in a cylinder, a combustion chamber defined by the cylinder and the piston and a combustion chamber liner. The combustion chamber liner may comprise an open porosity ceramic comprising high aspect ratio morphology material with a porosity of at least 85 percent. The material may comprise a material selected from a group consisting of alumina, zirconia, chromia, thoria, magnesia, carbon and silica.

In an embodiment, the combustion chamber liner may comprise advanced materials such as the following materials used by NASA: Lockheed Insulation (“LI”), Toughened Uni-Piece Fibrous Insulation (“TUFI”), Fibrous Refractory Composite Insulation (“FRCI”), and AETB. In an arrangement, the combustion chamber liner may comprise at least twenty percent by weight of AETB. The combustion chamber liner may have a coating material that forms a region at the surface of the liner where the coating occupies the porosity of the liner. In this regard, the liner may contain at least two distinct layers.

In still another aspect, a method of operating an ICE in a steady state condition is provided. The method includes ingesting a volume of air into a cylinder, compressing, within the cylinder, the volume of air, injecting a predetermined amount of fuel into the volume of air, igniting the fuel and converting a portion of the energy released due to the igniting step into mechanical energy in the form of rotational output of the ICE. The volume of air may be at a first temperature as it enters the cylinder and the temperature may be maintained during the compressing step, prior to ignition, within 300 degrees Celsius of that first temperature. The fuel may be injected directly into the combustion chamber.

In yet another aspect, a method of operating a four-stroke internal combustion engine is provided. The method may include ingesting a volume of air into a cylinder during an intake stroke, compressing, within the cylinder, the volume of air during a compression stroke, injecting a predetermined amount of fuel into the volume of air, igniting the fuel, converting a portion of the energy released from combustion into mechanical energy during a power stroke, and ejecting exhaust gases from the cylinder during an exhaust stroke. The mechanical energy may be in the form of rotational output of the ICE. The volume of air may be at a first temperature as it enters the cylinder during the intake stroke. While the ICE is operating in a steady state condition, a temperature of the exhaust gases as they leave the cylinder may be within 375 degrees Celsius of the first temperature.

In an embodiment, an intake valve to the cylinder may be maintained in a closed position for at least a portion of the intake stroke. In this regard, an effective intake stroke may be shorter than the full length of the movement of the piston within the cylinder. The portion of the intake stroke during which the intake valve is closed may be adjustable.

In an embodiment, while the ICE is operating in a steady state condition and prior to the igniting step, the temperature of the volume of air within the cylinder may be maintained within 300 degrees Celsius of the first temperature during the compression stroke.

In another aspect, a method of operating a four-stroke internal combustion engine is provided that includes providing an insulating liner within a cylinder of an ICE, ingesting a volume of air into the cylinder during an intake stroke, compressing, within the cylinder, the volume of air during a compression stroke, injecting a predetermined amount of fuel into the volume of air, igniting the fuel, converting a portion of the energy released due to the igniting step into mechanical energy in the form of rotational output of the ICE during a power stroke, and ejecting exhaust gases from the cylinder during an exhaust stroke. The insulating liner may comprise an open porosity ceramic with a high aspect ratio morphology material. The porosity of the open porosity ceramic may be at least 85 percent. In an embodiment, the material may comprise a material selected from a group consisting of alumina, zirconia, chromia, thoria, magnesia, carbon and silica.

The various features discussed above in relation to each aforementioned aspect may be utilized by any of the aforementioned aspects. Additional aspects and corresponding advantages will be apparent to those skilled in the art upon consideration of the further description that follows.

### BRIEF DESCRIPTION OF THE DRAWINGS

FIGS. 1-6 are schematic diagrams of various positions of a piston within a cylinder of an ICE.

FIG. 7 is a graph of heat flow through a cylinder wall as a function of piston position in a typical ICE.

FIG. 8 is a diagram representing energy flow in a prior art ICE.

FIG. 9 is a diagram representing energy flow in an ICE according to embodiments described herein.

FIG. 10 is a flow diagram of a method of operating an ICE.

### DETAILED DESCRIPTION OF THE INVENTION

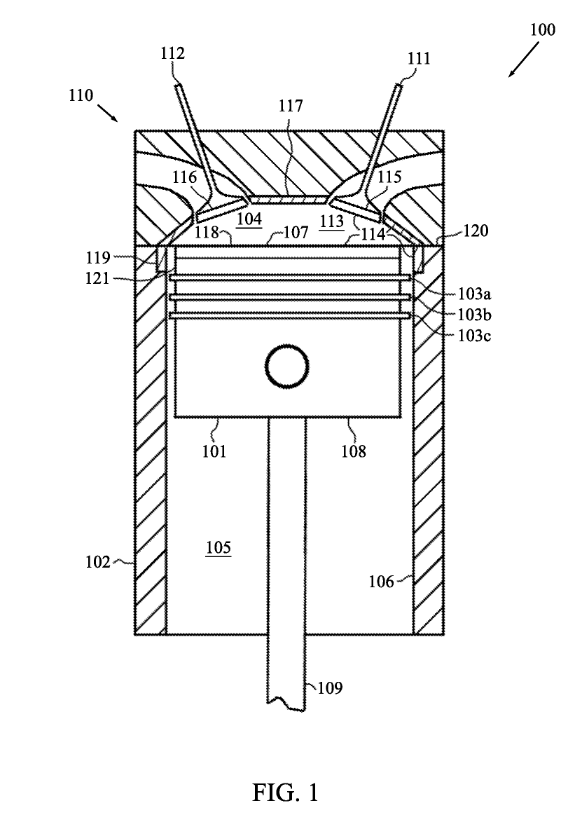

FIG. 1 is a cross-sectional schematic diagram of a portion of an ICE 100. The portion 100 includes a piston 101 disposed in a cylinder 102. The ICE 100 may contain additional similarly configured pistons and cylinders. A set of piston rings 103a, 103b, and 103c is interconnected to the piston 101. The set of piston rings 103a, 103b, and 103c restricts the flow of material (e.g., combustion gases) between a volume 104 above the piston rings 103a, 103b, and 103c and a volume 105 below the piston rings 103a, 103b, and 103c. The piston rings 103a, 103b, and 103c also remain in contact with the cylinder wall 106 and help to minimize contact between the piston 101 and the cylinder wall 106. In this regard, it is beneficial to situate the uppermost piston ring 103a closer to the top 107 of the piston 101 then to the bottom 108 of the piston 101. In this manner, the piston rings 103a, 103b, and 103c assist in keeping the piston 101 aligned with in the cylinder 102 and prevent the top 107 of the piston 101 from contacting the cylinder wall 106. The piston 101 is also interconnected to a connecting rod 109 that is interconnected to a crankshaft of the engine (not shown).

A portion of a cylinder head 110 is also illustrated in the cross-sectional schematic diagram of FIG. 1. The portion of the cylinder head 110 includes at least one intake valve 111 and at least one exhaust valve 112 for controlling the flow of material into and out of the cylinder 102. The valves 111 and 112 may be actuated through a mechanical link to the crankshaft or by other means known to those skilled in the art (e.g., electronic actuators). Additionally, the timing of the opening and closing of the valves 111 and 112 relative to the position of the piston 101 may be variable. This variability may be achieved by apparatuses and methods known to those skilled in the art.

In FIG. 1, the piston 101 is illustrated in the TDC position. In the TDC position, the piston 101 and the portion of the cylinder head 110 together define a combustion chamber 113. An ignition source (e.g., spark plug, glow plug) may be disposed within the combustion chamber 113.

The combustion chamber 113 and portions of the cylinder wall 106 may include an insulating liner 114. The insulating liner 114 may include several distinct portions interconnected to various components lining the combustion chamber 113. Valve liners 115 and 116 may be disposed on the faces of the valves 111 and 112, respectively. Cylinder head liner 117 may be disposed on those portions of the cylinder head 110 that line the combustion chamber 113. Piston top liner 118 may be disposed along the top 107 of the piston 101. In this regard, a majority of the surfaces along the periphery of the combustion chamber 113 may be lined with the insulating liner 114.

A portion of the cylinder wall 106 situated between the uppermost piston ring 103a when the piston in 101 is in the TDC position (as illustrated and FIG. 1) and the top 120 of the cylinder 102 may contain a cylinder wall liner 119. Optionally, the piston top liner 118 may include a side section liner (not shown) disposed along the sides 121 of the piston 101 above the uppermost piston ring 103a.

A function of the insulating liner 114 may be to act as an insulator and restrict the flow of heat from the combustion chamber 113 to the surrounding components (e.g., the cylinder head 110, cylinder 102 and piston 101). In this regard, as the length of the cylinder wall liner 119 is increased (e.g., the further the cylinder wall liner 119 extends along the cylinder wall 106 from the top 120 of the cylinder 102), a greater portion of the surface of the cylinder wall 106 may be insulated resulting in a correspondingly increased restriction of the flow of heat.

The insulating liner 114 may be constructed from materials that may not possess the same wear capabilities as typical cylinder walls and piston rings known to those skilled in the art. In such a configuration, it may be undesirable for the cylinder wall liner 119 to come into frictional contact with the uppermost piston ring 103a. However, as noted above, there are advantages to having the uppermost piston ring 103a close to the top 107 of the piston 101. Indeed, prior art ICEs typically place the uppermost piston ring relatively close to the top of the piston. Therefore, it will be appreciated that the desire to insulate the cylinder wall 106 (e.g., by extending the cylinder wall liner 119 down the cylinder wall 106) may need to be balanced with the desire to place the uppermost piston ring 103a close to the top 107 of the piston 101.

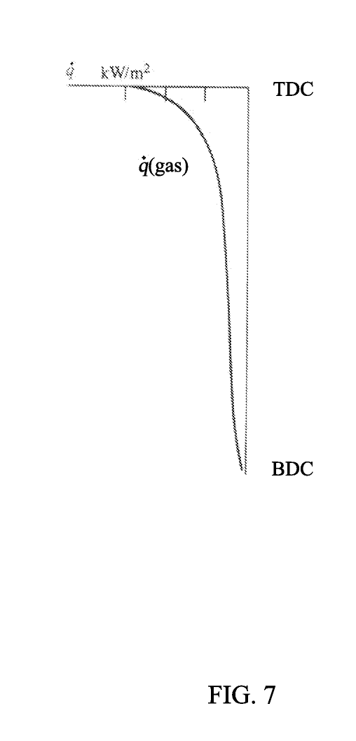

FIG. 7 is a chart showing heat flux distribution (q(gas)) from the gasses within the cylinder into the cylinder wall of a typical prior art ICE as a function of distance from the top of a cylinder. As can be seen, the majority of heat flow occurs toward the top of the cylinder with the amount of heat flow dropping off substantially as a function of distance from the top of the cylinder. In this regard, it has been determined that heat flow restriction from the combustion chamber 113 and cylinder 102 necessary to achieve the methods of operation of the lined ICE embodiments described herein may be achieved in part by lining a top portion of the cylinder wall 106. The cylinder wall liner 119 may be configured to be disposed in the region between the top 120 of the cylinder 102 and the uppermost piston ring 103a (when the piston 101 is at TDC) with the uppermost piston ring 103a positioned as typical in a prior art ICE. Alternatively, the uppermost piston ring 103a may be positioned lower on the piston 101 than as generally positioned in typical prior art ICEs.

In an exemplary embodiment, the cylinder wall liner 119 may extend down the cylinder wall 106 a distance equal to about 25 percent of the stroke length of the piston 101. In such an exemplary embodiment, the uppermost piston ring 103a may be positioned a corresponding distance from the top 107 of the piston 101 (e.g., within the top third of the piston 101).

In a specific embodiment, the piston 101 may have a diameter of 4 inches and a stroke length of 4 inches and the cylinder wall liner 119 may extend 1 inch from the top 120 of the cylinder 102. Accordingly, the uppermost piston ring 103a may be located 1.125 inches from the top 107 of the piston 101.

The insulating liner 114 may possess a low thermal conductivity and a low thermal capacity. The low thermal conductivity may limit heat flow from gases within the combustion chamber 113 to surrounding components such as the cylinder head 110, piston 101 and cylinder 102. The low thermal capacity may limit the total thermal energy that may be stored in the insulating liner 114 during a combustion cycle. The benefits of this combination of low thermal conductivity and low thermal capacity are discussed below with reference to the description of an operating cycle of the lined ICE 100.

The insulating liner 114 may be operable to withstand the conditions present within the combustion chamber 113. For example, the insulating liner 114 may be operable to withstand the mechanical stresses imparted on it by the repeated combustion of an air-fuel mixture within the combustion chamber 113. The insulating liner 114 may also be operable to withstand exposure to an air-fuel mixture (e.g., containing gasoline or diesel fuel) prior to ignition, exposure to a combusting air-fuel mixture and exposure to the byproducts of an air-fuel mixture combustion process. The insulating liner 114 may also be operable to withstand exposure to various lubricants or fuel additives that may be present in an ICE. It may also be desirable that the insulating liner 114 be resistant to accumulation of materials such as those that may be present in the byproducts of an air-fuel mixture combustion process.

To achieve the desired properties discussed herein, the insulating liner 114 may include an open porosity ceramic material. The ceramic material may comprise sintered ceramic fibers. The ceramic fibers may have a high aspect ratio. For example, the ceramic fibers may have an aspect ratio greater than 20 to one. Also, the ceramic fibers may have an aspect ratio less than 20,000 to one. The open porosity ceramic material they have a porosity of at least 85 percent. The open porosity ceramic material may have a thermal conductivity of at most 1.5 W/m·K and a thermal capacity of at most 1,200 J/kg·K. The open porosity ceramic material may comprise alumina, zirconia, chromia, thoria, magnesia, carbon, silica or a combination thereof.

The open porosity ceramic material may comprise materials such as those described in U.S. Pat. No. 5,079,082 to Leiser at al., the entirety of which is incorporated herein by reference. The open porosity ceramic material may comprise advanced materials such as the following materials used by NASA: LI, TUFI, FRCI and AETB. These materials each comprise high aspect ratio fibers sintered together to form highly porous materials with low thermal conductivity and low thermal capacity. In an exemplary embodiment, the insulating liner 114 may comprise at least twenty percent by weight of AETB.

An open porosity material may allow other materials such as the air-fuel mixture and combustion gases to enter into the porosity of the material. This may be undesirable since the thermal conductivity and thermal capacity of the material may be negatively altered by the presence of the other materials. To prevent such contamination of the porosity of the insulating liner 114, a coating may be added to the insulating liner 114. The coating may be disposed within the porosity of the insulating liner 114 near the inner surface (e.g., the surface of the insulating liner 114 facing the combustion chamber 113) of the insulating liner 114. The coating may be applied to the insulating liner 114 using methods known to those skilled in the art. The coating may comprise porous alumina, zirconia, chromia, thoria, magnesia, carbon, silica, or a combination thereof. The coating may have a thermal conductivity of at most 1.5 W/m·K and a thermal capacity of at most 1,400 J/kg·K. For example, a coating consisting of zirconia and silica as described in U.S. Pat. No. 5,034,358 to MacMillan, the entirety of which is hereby incorporated by reference, may be applied to the insulating liner 114.

The coating may occupy a region of the porosity of the open porosity ceramic material at the inner surface of the insulating liner 114 without forming a separate layer of coating on the surface of the insulating liner 114. Accordingly, since the addition of coating to the open porosity ceramic material may not change the overall dimensions of the open porosity ceramic material (since the coating only occupies a portion of the porosity of the open porosity ceramic material), the insulating liner 114 may be produced to its final size and shape prior to the coating process. In this regard, no compensation for the coating process may need to be implemented during the open porosity ceramic material production process.

The insulating liner 114 in its final form may contain two distinct regions: a first region where the porosity of the open porosity ceramic material is at least partially filled with the coating and a second region where the open porosity ceramic material remains substantially free from the coating. The second region may contain gases within the open porosity ceramic material (e.g., air, nitrogen) or it may be free from gases (e.g., a vacuum).

Each individual section of the insulating liner 114 (e.g., valve liners 115 and 116, cylinder head liner 117, cylinder wall liner 119, and piston top liner 118) may be uniquely configured. For example, the cylinder head liner 117 may have a different thickness and/or chemical composition than the piston top liner 118. In one embodiment, the insulating liner 114 may have a thickness of greater than 0.001 inches. In another embodiment, the insulating liner 114 may have a thickness of between 0.001 inches and 1.000 inches. The insulating liner 114 may have an operating temperature range with an upper limit of 1,425 to 1,670 degrees Celsius.

A four-stroke engine cycle for the portion of the ICE 100 of FIG. 1 and corresponding functions of various components will now be described with reference to FIGS. 1 through 6. In an ICE, combustion of the air-fuel mixture causes a rapid rise in pressure within a cylinder that is used to drive a piston. By insulating the cylinder with the insulating liner 114 described herein, more heat can be retained within the cylinder as compared to a cylinder without the insulating liner 114. Consequently, cylinder pressure will be higher and more of the energy released during combustion may be converted into movement of the piston. By operating the ICE 100 with the insulating liner 114 using an over-expanded cycle (e.g., Atkinson cycle), further efficiency advantages may be realized. For example, a greater percentage of the energy released during combustion can be converted to piston movement as compared to a typical, similarly configured prior art ICE.

The embodiment of an engine cycle described herein is an exemplary diesel engine cycle of an ICE 100 containing an insulating liner 114 as described herein and is not intended to be limiting. Those skilled in the art will recognize that variations in components (e.g., number of valves), variations in the timing of events (e.g., valve opening and closing, ignition), and variations of engine type (e.g., gasoline, diesel) from the present example are possible and fall within the scope of the present invention.

FIG. 1 illustrates the piston 101 at TDC prior to the start of the intake stroke and at the completion of a preceding exhaust stroke. This position corresponds to 0 degrees of crankshaft angle. In a steady state condition, the inner surface of the insulating liner 114 may be at a temperature of about 500 degrees Celsius at this point in the engine cycle. The inner surface is the surface of the insulating liner 114 facing the combustion chamber 113. The outer surface of the insulating liner 114 may be at a lower temperature. The outer surface of the insulating liner 114 is the surface opposite of the inner surface that is generally facing away from the combustion chamber 113 and is in contact with other components of the ICE 100. The difference between the temperatures of the inner and outer surfaces of insulating liner 114 is due in part to the insulative properties of the insulating liner 114.

As stated, the insulating liner 114 may have a low heat capacity and low thermal conductivity. Accordingly, the temperature of the inner surface of the insulating liner 114 will tend to fluctuate as the temperature of the gases within the cylinder fluctuates. This may be a result of the gases within the cylinder transferring heat energy to the inner surface of the insulating liner 114, which due to its relatively low heat capacity may quickly absorb an amount of heat energy from the gases to bring the inner surface close to the temperature of the gases within the cylinder. Similarly, when the temperature of the gases within the cylinder drop (e.g., during the power stroke and intake stroke), the relatively small amount of heat energy stored in the surface of the insulating liner 114 may be quickly released into the gases and the temperature of the insulating liner 114 may drop accordingly.

In addition, since the insulating liner 114 has a low thermal conductivity, the temperature of the outer surface of the insulating liner 114 will tend to be more constant through the engine cycle since only a limited portion of the heat energy at the inner surface of the insulating liner 114 will be conducted through the insulating liner 114 to the outer surface of the insulating liner 114. This can be contrasted to a typical cylinder wall temperature profile of a typical similarly configured prior art ICE. In the typical similarly configured prior art ICE, the cylinder materials (e.g., cast iron) have a much higher heat capacity and thermal conductivity. Accordingly, more heat energy may be absorbed into and stored in the typical similarly configured prior art ICE cylinder.

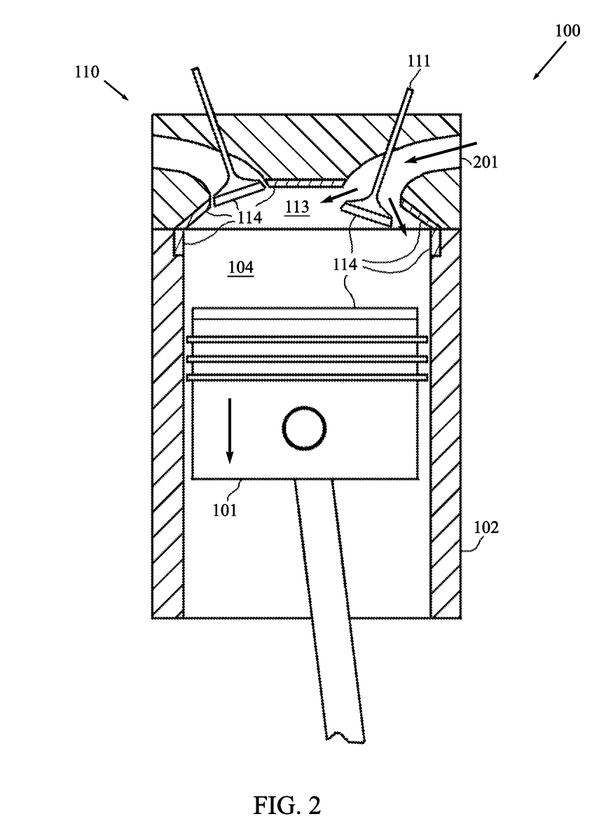

As illustrated in FIG. 2, during at least a portion of the intake stroke, a volume of air may be drawn into the cylinder 102 past an open intake valve 111. The air flows into the volume 104 above the piston rings due to a pressure differential between the volume 104 and the pressure within the intake passage 201. In direct injection embodiments of the ICE 100, fuel may be injected directly into the cylinder 102 through a fuel injector (not shown) located within the combustion chamber 113. In an embodiment of the ICE 100 using multi-point fuel injection, an air-fuel mixture may be ingested in place of the volume of air.

At the beginning of the intake stroke, the insulating liner 114 may be at a temperature substantially equal to or greater than that of the exhaust gas of the previous engine cycle. As a result, at the beginning of the intake stroke the gas entering the cylinder may be heated by the insulating liner 114. As more relatively cool gas flows into the cylinder, the overall temperature of the gas within the cylinder may drop.

After the initial reduction of gas temperature, the gas temperature within the cylinder may remain relatively stable during the remaining portion of the intake stroke and through much of the compression stroke. The faster cooling of the intake gases and the relatively lower gas temperature during the intake and exhaust strokes, as compared to the typical similarly configured prior art ICE may be due to the low amount of heat energy stored in the insulating liner 114 relative to the amount of heat energy stored in typical (e.g., cast iron) combustion chamber walls. This lower amount of stored energy results in a lower amount of energy being transferred to the gases within the cylinder and hence the lower gas temperature. In a conventional, metal lined cylinder, the cylinder walls may be capable of storing and releasing much more heat energy into the gases within the cylinder, resulting in higher overall temperatures.

Accordingly, in lined ICE 100 embodiments described herein, during the intake stroke the incoming air may, for example, be heated to a temperature of about 200 degrees Celsius above ambient when the engine is at Bottom Dead Center (“BDC”), e.g., 180 degrees of crankshaft angle. In an embodiment, the temperature of the gases within the cylinder during the compression stroke and prior to ignition may be maintained within 300 degrees Celsius of the temperature of the air entering the cylinder during the intake stroke, not withstanding the heating due to compression.

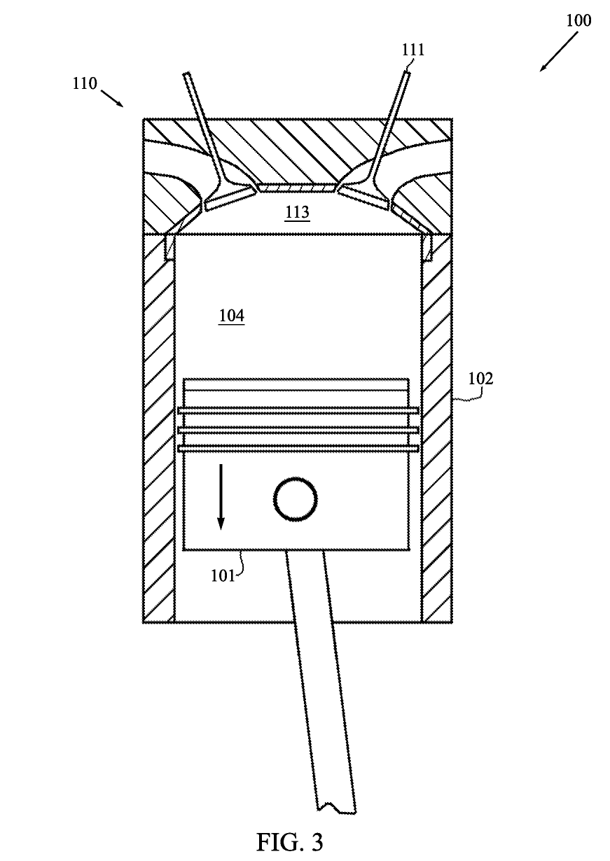

Turning to the FIG. 3, at a predeterminable point during the intake stroke, the intake valve 111 may be closed. FIG. 3 represents the engine at about 150 degrees of crankshaft angle. If the intake valve 111 is closed prior to completion of the intake stroke, as illustrated in FIG. 3, a modified Atkinson cycle may be achieved. In this regard, the portion of the intake stroke that occurs while the intake valve 111 is open may be considered the effective intake stroke of the cylinder. An Atkinson cycle engine is one where the power stroke is longer than the effective intake stroke and corresponding effective compression stroke. Such an arrangement allows more energy to be extracted from the intake volume than is typically achievable in a conventional four-stroke engine where the intake stroke and the power stroke are of generally equal length. Other methods of achieving an Atkinson cycle may be utilized. For example, an Atkinson cycle may be achieved by having the intake vale open during a portion of the compression stroke, thereby ejecting gases from the cylinder into the intake manifold. This would also result in the power stroke being longer than the effective intake stroke. Other methods of achieving asymmetric engine cycles where a power stroke is longer than an effective intake stroke may also be utilized.

Through the use of variable valve timing, the length of the power stroke relative to the effective length of the intake stroke may be varied. For example, closing the intake valve 111 at an earlier point during the intake stroke will result in the effective intake stroke being a reduced percentage of the length of the power stroke. Likewise, leaving the intake valve 111 open during the entire intake stroke will result in about a one-to-one ratio of the length of the intake stroke to the length of the power stroke, such as typical in a non-Atkinson ICE.

The variable valve timing may be operable to alter the ratio of length of power stroke to effective intake stroke from, for example, 5:1 to 1.05:1. The ratio may be varied depending on the power requirements of the engine at any particular time. For example, if maximum power output is required, the intake valve 111 may be held open during a longer than typical portion of the intake stroke thereby maximizing the amount of air ingested into the cylinder. Such an action may result in a temporary lowering of the efficiency of the engine. Similarly, if the power requirements of the engine are relatively low, the intake valve 111 may be closed earlier during the intake stroke so that less air is ingested into the cylinder. In an embodiment, the ICE 100 may, under normal operating conditions, ingest about one-third to one-half less mass of air than ingested by a similarly configured prior art ICE.

Other methods known to those skilled in the art of achieving asymmetrical intake and power strokes may also be utilized (e.g., Miller cycle).

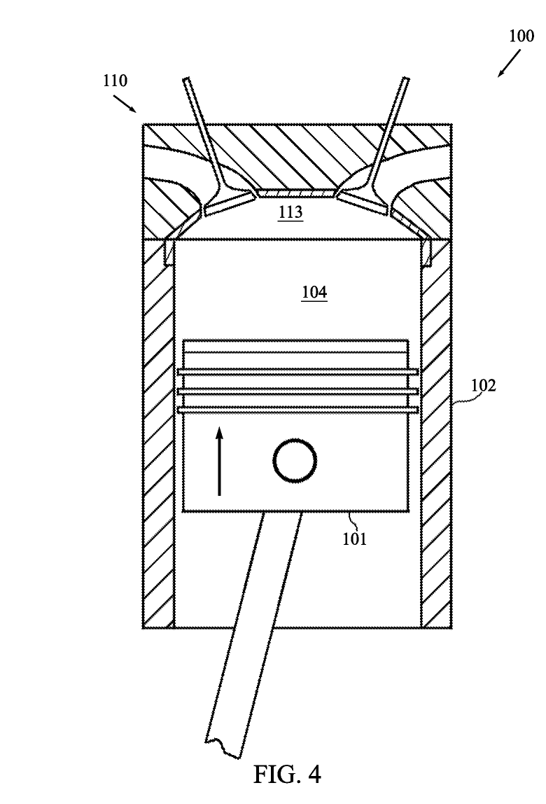

FIG. 4 illustrates the compression stroke as the piston 101 moves toward TDC. FIG. 4 represents the engine cycle at about 300 degrees of crankshaft angle. During this stroke, the gasses ingested during the intake stroke are compressed. The gas within the cylinder may be heated due to compression.

Proximate to the end of the compression stroke, ignition may occur. In diesel fuel embodiments, ignition may occur when the fuel is directly injected into the combustion chamber and the air-fuel mixture is compressed to a critical point where ignition happens spontaneously. The amount of fuel injected into the cylinder may correspond to the mass of air ingested during the preceding intake stroke. For example, the amount of fuel injected may be chosen to achieve a stoichiometric air-fuel ratio. In an embodiment, ignition may be triggered by the introduction of a spark within the combustion chamber.

Once ignition occurs, the air-fuel mixture within the cylinder will combust releasing heat and causing the pressure within the cylinder to rise. The gas temperature within the cylinder rises sharply after ignition. Once started by ignition, combustion may continue as the piston travels through TDC into the power stroke. The inner surface of the insulating liner 114 may also rapidly rise in temperature. Again, this is due to the relatively low heat capacity of the insulating liner 114, which results in the inner surface of the insulating liner 114 absorbing energy from ignition and rapidly rising in temperature. However, due to the low thermal conductivity, the temperature of the outer surface of the insulating liner 114 may not experience a significant increase in temperature.

About 40 percent of the energy transferred to the insulating liner 114 during the combustion process may be from radiant energy generated during combustion. In this regard, the amount of radiant energy that is transferred into the insulating liner 114 may be partially dependent on the reflectivity of the inner surface of insulating liner 114.

As will be appreciated, as the thickness of the insulating liner 114 is increased, the difference in temperature between the inner surface of the insulating liner 114 and the outer surface of the insulating liner 114 may also increase. In an embodiment, the thickness of the insulating liner 114 may be greater than 0.001 inches. The thickness of the insulating liner 114 may, for example, be between 0.001 and 1.0 inches.

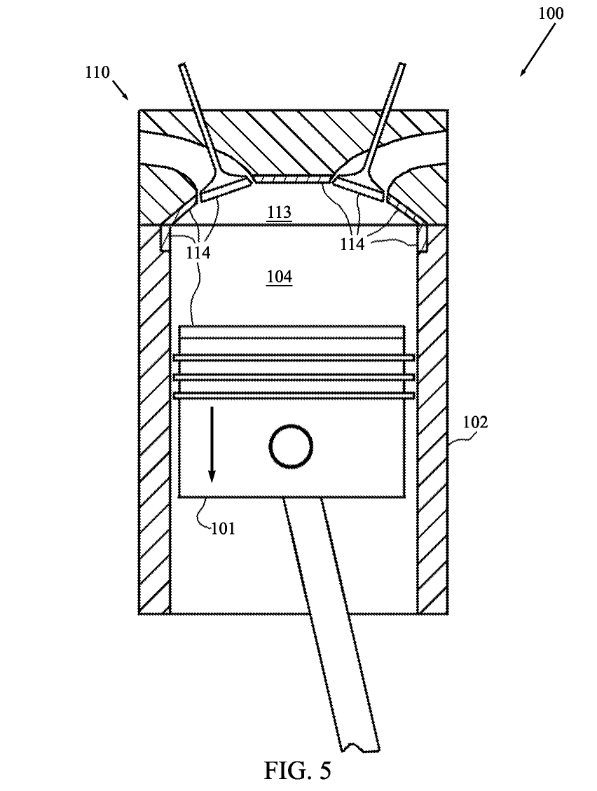

FIG. 5 depicts the power stroke as the piston 101 moves downward in response to a rapid expansion of the combustion gases within the chamber. FIG. 5 represents the engine cycle at about 450 degrees of crankshaft angle. As the gases expand during the power stroke, energy from the combustion gases is converted to kinetic energy in the form of movement of the piston 101. As noted, the insulating liner 114 may limit the amount of heat energy flowing out of the cylinder through the combustion chamber periphery.

The peak combustion temperature of the gases within the cylinder of the lined ICE 100 and a similarly configured prior art ICE may be similar. However, during the power stroke the temperature within the cylinder of the lined ICE 100 decreases at a greater rate than that of a similarly configured prior art ICE. One reason for the increased rate of cooling of the lined ICE 100 combustion gases is because the lined ICE 100 started, as noted above, with a smaller charge (e.g., typically one third to one half less of a charge than a similarly configured prior art ICE). Consequently, as the combustion gases expand, the temperature of those gases falls rapidly relative to a similarly configured prior art ICE. This may be due to the rate of volume expansion within the cylinder relative to the quantity of combustion gases within the cylinder being greater in the lined ICE 100. The continued higher rate of cooling through the entire power stroke is also due to the overexpansion of the cylinder relative to the intake stroke. This greater rate of cooling occurs even though the ICE 100 is lined and a reduced amount of heat may leave the cylinder through the cylinder walls. In this regard it can be seen how a greater percentage of the energy of combustion of the lined ICE 100 may be converted into mechanical energy (e.g., piston movement) than in a typical similarly configured prior art ICE.

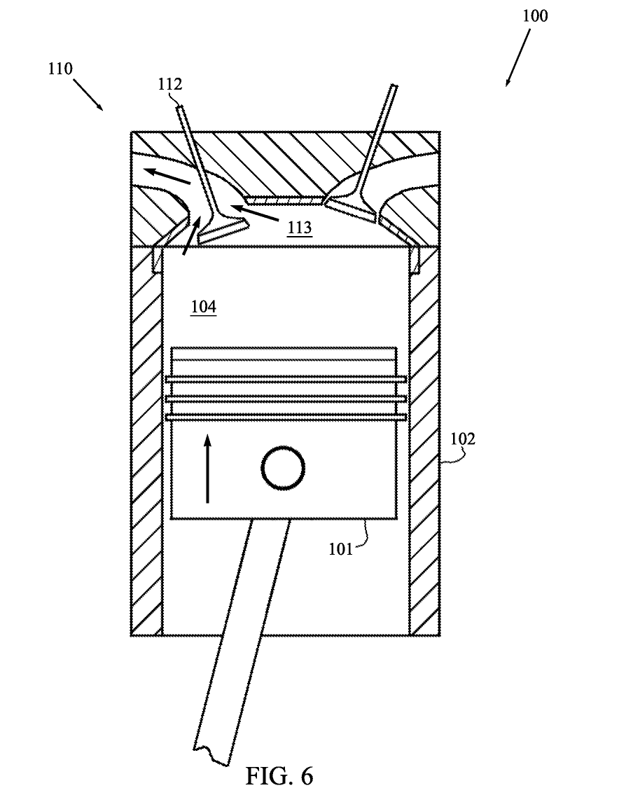

FIG. 6 shows the exhaust stroke as the piston 101 moves upward and the exhaust valve 112 opens. FIG. 6 represents the engine cycle at about 670 degrees of crankshaft angle. Since, as described above, a greater portion of the energy of combustion will be converted into kinetic energy, the gases within the cylinder of the lined ICE 100 will be at a correspondingly lower temperature than as compared to a typical similarly configured prior art ICE. The lined ICE 100 may be operable to run at a steady-state condition where the exhaust gases leaving the combustion chamber are at a temperature of less than 400 degrees Celsius. In an embodiment, the exhaust gas temperature may be within 375 degrees Celsius of the temperature of the air entering the cylinder during the intake stroke. The relatively lower exhaust gas temperatures indicate that less energy is being expelled from the cylinder in the form of heat energy within the exhaust gases.

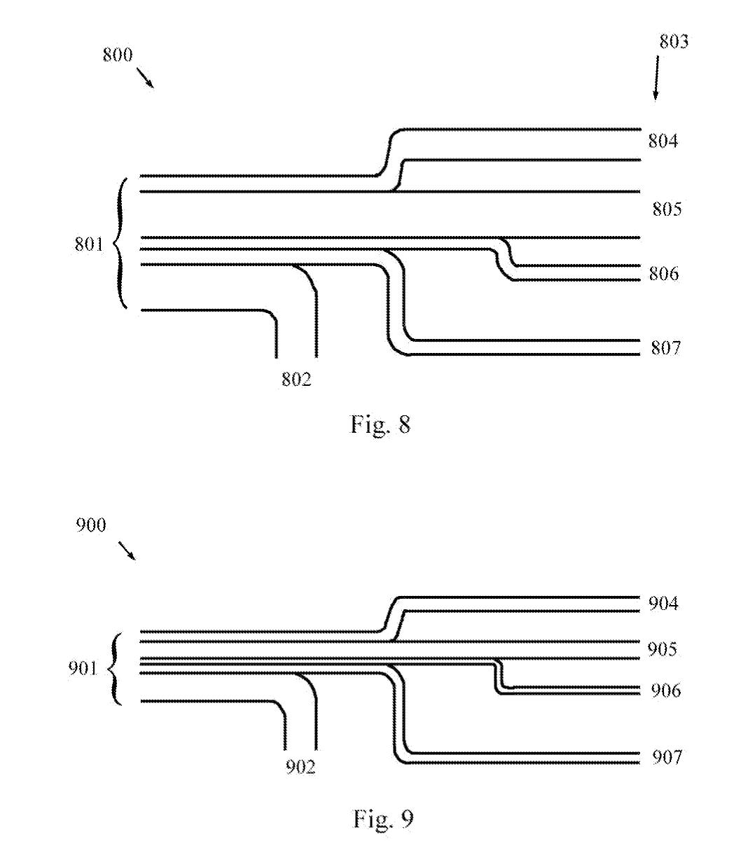

FIG. 8 is an energy flow diagram for a prior art ICE 800. The input to the diagram on the left side represents the total available energy 801 entering into the system. This is the total possible combustion energy available in the fuel entering the prior art ICE 800. A portion of the total available energy 801 is converted into the power output 802 of the prior art ICE 800. The remainder 803 of the total available energy 801 is not converted into the power output of the prior art ICE 800. The ratio of the power output 802 of the prior art ICE 800 to the total available energy 801 is the overall efficiency of the prior art ICE 800.

In the prior art ICE 800 of FIG. 8, a portion of the total available energy 801 is transferred to the engine coolant in the form of heat energy to the engine coolant 804. This heat energy 804 is typically transferred to the local environment via a radiator. Another portion of the total available energy 801 is typically ejected from the engine in the form of heat in the exhaust gases 805. This heat energy 805 is typically vented to the atmosphere by the exhaust system. Although in some prior art applications some of this energy may be recaptured through turbocharging. Another portion 806 of the total available energy 801 that is not converted into the power output 802 is typically due to incomplete combustion of the air-fuel mixture. Finally, another portion of the total available energy 801 that is not converted into the power output 802 is typically due to miscellaneous losses 807, such as, for example, frictional losses and exhaust gas kinetic energy.

FIG. 9 is an exemplary energy flow diagram for an ICE 900 that includes the insulating liner 114 described herein and is operated according to methods described herein. The prior art ICE 800 and the ICE 900 are similarly configured except that the ICE 900 includes the insulating liner 114 and is operated using the previously described Atkinson cycle. As can be seen, the ICE 900 ingests 901 between about one third and one half less fuel than the prior art ICE 800. Nonetheless, the power output 902 of the ICE 900 is about two-thirds the power output 802 of the prior art ICE 800.

As previously discussed, the insulating liner 114 may insulate the interior of the combustion chamber thereby preventing much of the heat generated within the combustion chamber from exiting the combustion chamber through the combustion chamber walls when compared to the prior art ICE 800. This is illustrated in FIGS. 8 and 9 where the amount of heat rejected to the engine coolant 904 of the ICE 900 is less than the amount of heat rejected to the engine coolant 804 of the prior art ICE 800.

Also as previously discussed, the combination of asymmetrical intake and power strokes and the insulating liner 114 combining low heat conductivity with low heat capacity may enable the ICE 900 to both heat gases entering the combustion chamber to a lower degree and to extract more heat energy from the combustion gases than the prior art ICE 800. Accordingly, the heat energy 905 present in the exhaust gases of the ICE 900 may be less than the heat energy 805 present in the prior art ICE 800. This is illustrated in FIGS. 8 and 9 where the amount of heat energy in the exhaust gases 905 of the ICE 900 is less than the amount of heat energy in the exhaust gases 805 of the prior art ICE 800.

The amount of energy not converted to output power of an engine due to incomplete combustion may be strongly related to the total amount of available energy inputted into the engine. Thusly, as the ICE 900 of FIG. 9 requires significantly less overall fuel to achieve its power output as compared to the prior art ICE 800 of FIG. 8, the losses due to incomplete combustion 906 may also be lower. This is illustrated in FIGS. 8 and 9 where the amount of losses due to incomplete combustion of the air fuel mixture 906 of the ICE 900 is less than the amount of losses due to incomplete combustion of the air fuel mixture 806 of the prior art ICE 800.

Additionally, other efficiency advantages may be present. For example, due to the relatively lower amount of heat 904 rejected from the lined ICE 900, the lined ICE 900 may not require the heat removal capacity of a liquid coolant system. Consequently, the lined ICE 900 may be air-cooled and therefore not need an engine-driven water pump. Exhaust gas kinetic energy losses may be lower in the lined ICE 900 since the mass of combustion gases exhausted will be lower than the prior art ICE 800. In this regard, the miscellaneous losses 907 associated with the lined ICE 900 may be lower than those associated with the prior art ICE 800. Accordingly, the lined ICE 900 may operate with a greater overall efficiency than the prior art ICE 800.

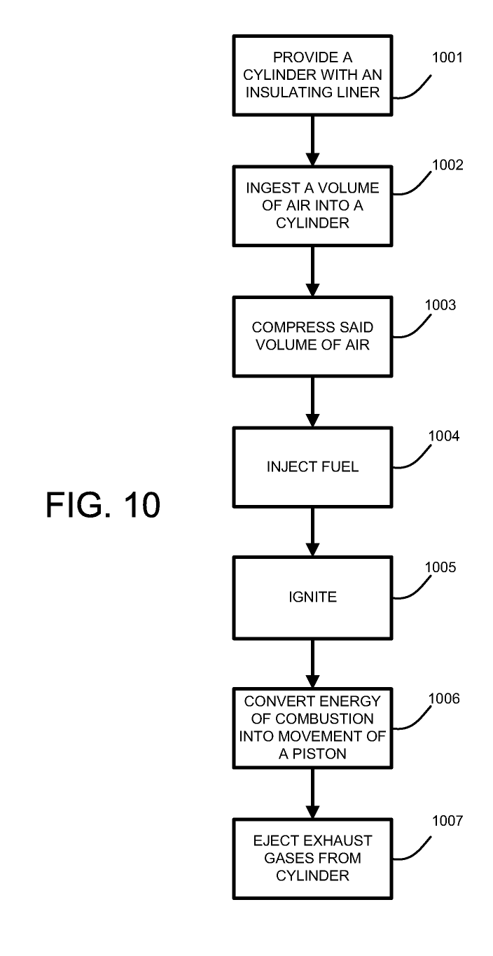

FIG. 10 is a flow diagram of a method of operating an ICE. Although the flow diagram illustrates particular steps in a particular order, this is for exemplary purposes only. The order of the steps may be rearranged from that depicted in FIG. 10. The first step 1001 may be to provide a cylinder of an ICE (e.g., a four-stroke diesel ICE utilizing the Atkinson cycle) with an insulating liner. The ICE may be operating in a steady state condition throughout performance of the present method. The liner may be configured as described above with reference to FIGS. 1 through 6. In particular, the liner may be an open porosity ceramic comprising high aspect ratio sintered fibers. Materials that the liner may comprise include, for example, alumina, zirconia, chromia, thoria, magnesia, carbon and silica. In a particular embodiment, the liner may comprise AETB with a coating on the surface of the liner facing a combustion chamber.

The next step 1002 may be to ingest a volume of air into the cylinder. In embodiments where the ICE does not use direct injection (e.g., multi-point fuel injection), the volume of air will also contain a volume of fuel. The volume of air ingested during any particular intake stroke may be adjustable through varying the timing of the opening and/or closing of the intake valve. The ingested air may be at a first temperature.

The following step 1003 may be to compress the volume of air within the cylinder. As described herein, the cylinder may have a liner with a relatively low heat capacity. This may, as described herein, allow the temperature of the air within the cylinder during the compression stroke and prior to ignition to remain within 300 degrees Celsius of the first temperature.

Step 1004 may include injecting a predetermined amount of fuel into the volume of air. In direct injection ICEs, this may include injecting the fuel directly into the compressed air within the cylinder. The amount of fuel injected may be determined by, inter alia, engine load, throttle position, the mass of air present in the cylinder, engine temperature and desired efficiency levels.

Next, step 1005 may include igniting the mixture of air and fuel within the combustion chamber. This may be a result of the activation of a separate ignition source, such as a spark plug in a gasoline ICE or a glow plug in a diesel ICE, or it may be the result of the combination of pressure and heat present in a direct injection diesel ICE. Ignition may be timed to occur during the latter portions of the compression stroke of the ICE. Ignition timing may be variable and determined based on present operating conditions and requirements.

The following step 1006 may be to convert a portion of the energy released during combustion into mechanical energy in the form of movement of the piston and rotational output of the ICE. This will occur during the power stroke of the ICE as the piston moves in response to the expanding combustion gases.

The next step 1007 may be to eject exhaust gases from the cylinder during an exhaust stroke. As described herein, the over-expansion of the ICE coupled with the effects of the liner may result in a lower exhaust gas temperature as compared to a similarly configured prior art ICEs. In this regard, the exhaust gas temperature as it leaves the cylinder may be within 375 degrees Celsius of the first temperature (during the intake stroke).

Additional modifications and extensions to the embodiments described above will be apparent to those skilled in the art. Such modifications and extensions are intended to be within the scope of the present invention as defined by the claims that follow.

What is claimed is:

1. An internal combustion engine comprising:
a. a piston assembly in a cylinder, said cylinder comprising a cylinder wall and a cylinder head, said piston assembly comprising a piston and at least one sealing ring, wherein a piston top surface is disposed in a facing relationship with a combustion chamber surface of said cylinder head;
b. a combustion chamber defined by said cylinder and said piston; and
c. an insulating liner, said insulating liner including:
a piston liner disposed on said piston top surface,
a cylinder wall liner disposed along a wall of said cylinder between said cylinder head and said at least one sealing ring when said piston is in a top dead center position, wherein a length of said cylinder wall liner along a movement axis of said piston is less than a stroke length of said piston, and
a cylinder head liner disposed on said combustion chamber surface of said cylinder head.

2. The internal combustion engine of claim 1, said piston further comprising a piston bottom, wherein at least one of said at least one sealing ring is positioned closer to said piston top surface than said piston bottom.

3. The internal combustion engine of claim 2, said piston further comprising a piston length defined as the distance between said piston bottom and said piston top surface, wherein at least one of said at least one sealing ring is positioned within one third of said piston length from said piston top surface.

4. The internal combustion engine of claim 1, wherein said insulating liner has a thickness of greater than 0.001 inches.

5. The internal combustion engine of claim 1, wherein said insulating liner comprises Alumina-Enhanced Thermal Barrier.

6. The internal combustion engine of claim 1, wherein said insulating liner comprises aerogel.

7. The internal combustion engine of claim 1, wherein said insulating liner has a thermal diffusivity less than 1.3×10⁻⁵ m²/s.

8. The internal combustion engine of claim 1, wherein said insulating liner has a thermal conductivity of at most 1.5 W/m K, wherein said insulating liner has a thermal capacity of at most 1,200 J/Kg K.

9. The internal combustion engine of claim 8, wherein said insulating liner has an operating temperature range with an upper limit of 1,670 degrees Celsius.

10. The internal combustion engine of claim 8, wherein said insulating liner comprises an open porosity ceramic comprising high aspect ratio morphology material, said open porosity ceramic having a porosity of at least 85%, and said material comprising a material selected from a group consisting of alumina, zirconia, chromia, thoria, magnesia, carbon and silica.

11. The internal combustion engine of claim 10, wherein said insulating liner comprises Alumina-Enhanced Thermal Barrier, wherein said insulating liner includes a coating, wherein said coating has a thermal conductivity of at most 1.5 W/m K, wherein said coating has a thermal capacity of at most 1,400 J/Kg K.

12. The internal combustion engine of claim 10, wherein said insulating liner comprises Alumina-Enhanced Thermal Barrier, wherein said insulating liner includes a coating comprising one or more materials selected from a group consisting of porous alumina, zirconia, chromia, thoria, magnesia, carbon and silica.

13. The internal combustion engine of claim 10, wherein said insulating liner comprises Alumina-Enhanced Thermal Barrier, wherein said insulating liner includes a coating comprising zirconia and silica.

14. The internal combustion engine of claim 10, wherein an aspect ratio of the morphology of said high aspect ratio morphology material is at least 20 to one.

15. The internal combustion engine of claim 1, wherein said insulating liner further includes a piston sidewall liner disposed on said piston between said piston top surface and said at least one sealing ring.

16. The internal combustion engine of claim 1, wherein said cylinder further comprises at least one intake valve and at least one exhaust valve, wherein an interior surface of said combustion chamber further includes a bottom surface of said at least one intake valve and a bottom surface of said at least one exhaust valve, and wherein said insulating liner further includes a lining of said bottom surface of said at least one intake valve and a lining of said bottom surface of said at least one exhaust valve.

17. The internal combustion engine of claim 1, wherein a power stroke of said internal combustion engine is longer than an effective intake stroke of said internal combustion engine.

18. The internal combustion engine of claim 1, wherein said internal combustion engine is operable to function using a four-stroke Atkinson cycle.

19. The internal combustion engine of claim 18, wherein the ratio of the length of the power stroke to the effective length of the intake stroke is between 5:1 and 1.05:1.

20. The internal combustion engine of claim 18, wherein said internal combustion engine incorporates variable valve timing.

21. The internal combustion engine of claim 1, wherein said internal combustion engine is operable to function using a four-stroke diesel cycle.

22. An internal combustion engine comprising:
a piston in a cylinder, said cylinder comprising a cylinder wall and a cylinder head;
a combustion chamber defined by said cylinder and said piston; and
a combustion chamber liner, said combustion chamber liner comprising an open porosity ceramic comprising high aspect ratio morphology material, said open porosity ceramic having a porosity of at least 85%.

23. The internal combustion engine of claim 22, wherein said combustion chamber liner comprises a material selected from a group consisting of LI, TUFI, FRCI, and AETB.

24. The internal combustion engine of claim 22, wherein said combustion chamber liner comprises Alumina-Enhanced Thermal Barrier.

25. The internal combustion engine of claim 22, wherein said combustion chamber liner comprises a material selected from a group consisting of alumina, zirconia, chromia, thoria, magnesia, carbon and silica.

26. The internal combustion engine of claim 22, wherein said combustion chamber liner has a thickness greater than 0.001 inches.

27. The internal combustion engine of claim 22, wherein said combustion chamber liner comprises at least 20 percent by weight of Alumina-Enhanced Thermal Barrier.

28. The internal combustion engine of claim 22, wherein said open porosity ceramic comprises at least two distinct layers.

29. The internal combustion engine of claim 22, wherein an aspect ratio of the morphology of said high aspect ratio morphology material is at least 20 to one.

30. The internal combustion engine of claim 22, wherein said combustion chamber liner includes a coating, wherein said coating has a thermal conductivity of at most 1.5 W/m K, wherein said coating has a thermal capacity of at most 1,400 J/Kg K.

31. The internal combustion engine of claim 22, wherein said combustion chamber liner includes a coating comprising one or more materials selected from a group consisting of porous alumina, zirconia, chromia, thoria, magnesia, carbon and silica.

32. The internal combustion engine of claim 22, wherein said combustion chamber liner includes a coating comprising zirconia and silica.

33. The internal combustion engine of claim 22, wherein said internal combustion engine is operable to function using an asymmetric cycle.

34. The internal combustion engine of claim 22, wherein said internal combustion engine is operable to function using a four-stroke diesel cycle.

35. A method of operating an internal combustion engine in a steady state condition comprising:
ingesting a volume of air into a cylinder, wherein said volume of air is at a first temperature as it enters said cylinder;
compressing, within said cylinder, said volume of air, wherein a temperature of said volume of air is maintained during said compressing step, prior to ignition, within 300 degrees Celsius of said first temperature;
injecting a predetermined amount of fuel into said volume of air;
igniting said predetermined amount of fuel; and
converting a portion of the energy released due to said igniting step into mechanical energy in the form of rotational output of said internal combustion engine.

36. The method of operating an internal combustion engine of claim 35, further comprising:
providing a combustion chamber with a liner comprising Alumina-Enhanced Thermal Barrier.

37. The method of operating an internal combustion engine of claim 35, further comprising:
providing a combustion chamber with a liner comprising an open porosity ceramic comprising high aspect ratio morphology material, said open porosity ceramic having a porosity of at least 85%, and said material comprising a material selected from a group consisting of alumina, zirconia, chromia, thoria, magnesia, carbon and silica.

38. The method of operating an internal combustion engine of claim 37, wherein an aspect ratio of the morphology of said high aspect ratio morphology material is at least 20 to one.

39. The method of operating an internal combustion engine of claim 35, further comprising operating said internal combustion engine using a four-stroke Atkinson cycle.

40. The method of operating an internal combustion engine of claim 35, further comprising operating said internal combustion engine using a four-stroke diesel cycle.

41. The method of operating an internal combustion engine of claim 35, further comprising injecting a predetermined amount of fuel directly into said cylinder.

42. A method of operating a four stroke internal combustion engine comprising:
during an intake stroke, ingesting a volume of air into a cylinder, wherein said volume of air is at a first temperature as it enters said cylinder;
during a compression stroke, compressing, within said cylinder, said volume of air;
injecting a predetermined amount of fuel into said volume of air;
igniting said predetermined amount of fuel;
during a power stroke, converting a portion of the energy released from said combustion into mechanical energy in the form of rotational output of said internal combustion engine; and
during an exhaust stroke, ejecting exhaust gases from said cylinder, wherein while said internal combustion engine is operating in a steady state condition, a temperature of said exhaust gases as they leave said cylinder is within 375 degrees Celsius of said first temperature.

43. The method of operating a four stroke internal combustion engine of claim 42, further comprising: providing a combustion chamber with a liner comprising Alumina-Enhanced Thermal Barrier.

44. The method of operating a four stroke internal combustion engine of claim 43, wherein an intake valve to said cylinder is maintained in a closed position for at least a portion of said intake stroke.

45. The method of operating a four stroke internal combustion engine of claim 44, wherein a duration of said portion of said intake stroke in which said intake valve is maintained in said closed position is adjustable.

46. The method of operating a four stroke internal combustion engine of claim 42, wherein a stroke length of said power stroke is at least 5 percent greater than an effective stroke length of said intake stroke.

47. The method of operating a four stroke internal combustion engine of claim 42, wherein during said compression stroke while said internal combustion engine is operating in a steady state condition and prior to said igniting step, a temperature of said volume of said air is maintained within 300 degrees Celsius of said first temperature.

48. A method of operating a four stroke internal combustion engine comprising:
providing an insulating liner within a cylinder of said internal combustion engine, said insulating liner comprising an open porosity ceramic comprising high aspect ratio morphology material, wherein said open porosity ceramic has a porosity of at least 85%;
during an intake stroke, ingesting a volume of air into said cylinder;
during a compression stroke, compressing, within said cylinder, said volume of air;
injecting a predetermined amount of fuel into said volume of air;
igniting said predetermined amount of fuel;
during a power stroke, converting a portion of the energy released due to said igniting step into mechanical energy in the form of rotational output of said internal combustion engine; and
during an exhaust stroke, ejecting exhaust gases from said cylinder.

49. The method of operating a four stroke internal combustion engine of claim 48, wherein said providing step further includes:
providing a piston liner portion of said insulating liner, said piston liner portion disposed on a top surface of a piston;
providing a cylinder wall liner portion of said insulating liner, said cylinder wall liner portion disposed along a wall of said cylinder between a cylinder head and a piston sealing ring when said piston is in a top dead center position, wherein a length of said cylinder wall liner along a movement axis of said piston is less than a stroke length of said piston; and
providing a cylinder head liner portion of said insulating liner, said cylinder head liner portion disposed on a combustion chamber surface of said cylinder head.

50. The method of operating a four stroke internal combustion engine of claim 48, wherein said insulating liner comprises Alumina-Enhanced Thermal Barrier.

51. The method of operating a four stroke internal combustion engine of claim 48, wherein said material comprises a material selected from a group consisting of alumina, zirconia, chromia, thoria, magnesia, carbon and silica.

52. The method of operating a four stroke internal combustion engine of claim 48, wherein an aspect ratio of the morphology of said high aspect ratio morphology material is at least 20 to one.

53. The method of operating a four stroke internal combustion engine of claim 48, wherein the ratio of the length of said power stroke to the effective length of said intake stroke is between 5:1 and 1.05:1.
